(19) United States
(12) Patent Application Publication
(10) Pub. No.: US 2026/0230136 A1
(43) Pub. Date: Aug. 6, 2026

(54) METHODS FOR JOINT SOURCE CHANNEL COMPRESSION AND MODULATION (JSCCM) BASED CHANNEL STATE INFORMATION (CSI) COMPRESSION AND FEEDBACK

(71) Applicant: InterDigital Patent Holdings, Inc., Wilmington, DE (US)

(72) Inventors: Ahmet Serdar Tan, London (GB); Yugeswar Deenoo Narayanan Thangaraj, Chalfont, PA (US); Patrick Tooher, Montreal (CA); Mohamed Salah Ibrahim, Chesterbrook, PA (US); Anouar Yatribi, Greater London (GB); Mihaela Beluri, Jericho, NY (US)

(73) Assignee: InterDigital Patent Holdings, Inc., Wilmington, DE (US)

(21) Appl. No.: 19/043,898

(22) Filed: Feb. 3, 2025

(51) Int. Cl. H04B 7/06; H04L 1/00; H04W 72/1268

(52) U.S. Cl. CPC H04B 7/0626; H04B 7/0658; H04L 1/0068; H04W 72/1268

(57) ABSTRACT

A wireless transmit/receive unit (WTRU) comprises a processor configured to receive configuration information. The configuration information may include, for example, an indication of a plurality of compressed channel state information (CSI) symbols (CCS) reporting modes, where each CCS reporting mode of the plurality of reporting modes may indicate a respective channel for reporting CCS symbols. The processor may be configured to determine a CCS reporting mode out of the plurality of CCS reporting modes. The processor may be configured to generate CCS symbols based on CSI reference signal (CSI-RS) measurements. The processor may be configured to determine a CCS reporting configuration based on the CCS reporting mode. The CCS reporting configuration may indicate, for example, resources of the channel associated with the CCS reporting mode. The processor may be configured to send a report via the resources of the channel associated with the determined CCS reporting mode.

### BACKGROUND

Artificial Intelligence or machine learning (AI/ML) based channel state information (CSI) compression is studied in the Third Generation Partnership Program (3GPP) as means to reduce the uplink (UL) CSI feedback reporting overhead for higher resolution downlink (DL) channel state information at the network (NW). The AI/ML-based CSI compression may use a two-sided autoencoder (AE) model, where the encoder part is located at the transmitter (e.g. wireless transmit/receive unit (WTRU)) side and/or compresses the high dimensionality input data (e.g., CSI) to a lower dimensionality latent vector. The decoder part may be located at the receiver (e.g., NW) side and/or performs the reconstruction based on the received latent vector (e.g., compressed CSI).

From an end-to-end perspective, current studies in 3GPP on CSI compression focuses on the separate source channel coding (SSCC) approach wherein the compressed CSI may be channel coded and symbol modulated separately, for example, as shown in FIG. 2. In the SSCC approach, the output of the encoder of CSI compression may be quantized and/or converted to binary to be used as input for the channel coding. The joint source channel compression and modulation (JSCCM) approach may be a more efficient end-to-end compression alternative for CSI feedback wherein the AE may be trained to perform CSI compression, channel coding and symbol modulation jointly, for example, as shown in FIG. 3. In the JSCCM approach, the output of the encoder of the CSI compression may be complex valued and/or can be used as input to an inverse fast Fourier transform (IFFT) block (e.g., orthogonal frequency division multiplexing (OFDM) Mapping and Modulation).

Deploying a JSCCM based approach for CSI feedback may require the elimination of channel coding and/or symbol modulation blocks in the physical (PHY) layer for channel state feedback. Additionally and/or alternatively, the output of the JSCCM encoder (e.g., Y in FIG. 3), compressed CSI symbols (CCS), may be a complex value and/or non-quadrature amplitude modulation (QAM) based, which in turn may cause issues. For example, CCS may cause increased peak-to-average-power ratio (PAPR) when the CCS is multiplexed with uplink resources in the physical uplink shared channel (PUSCH) and/or physical uplink control channel (PUCCH). The WTRU may report CCS efficiently and minimize impairments as discussed herein.

### SUMMARY

A wireless transmit/receive unit (WTRU) may comprise a processor. The processor may be configured to receive configuration information. The configuration information may include, for example, an indication of a plurality of compressed channel state information (CSI) symbols (CCS) reporting modes, where each CCS reporting mode of the plurality of reporting modes may indicate a respective channel for reporting CCS symbols. The processor may be configured to determine a CCS reporting mode out of the plurality of CCS reporting modes. The processor may be configured to generate CCS symbols based on CSI reference signal (CSI-RS) measurements. The processor may be configured to determine a CCS reporting configuration based on the CCS reporting mode. The CCS reporting configuration may indicate, for example, resources of the channel associated with the CCS reporting mode. The processor may be configured to send a report via the resources of the channel associated with the determined CCS reporting mode. The report may include, for example, the generated CCS symbols, the determined CCS reporting configuration, and/or the determined CCS reporting mode.

The plurality of CCS reporting modes may include, for example, two or more of a first mode associated with CCS multiplexed onto resources of a scheduled physical uplink shared channel (PUSCH) transmission, a second mode associated with CCS within a configurable physical uplink control channel (PUCCH) resource, and/or a third mode associated with a dedicated uplink channel for CCS.

The first mode may include, for example, a first option associated with a semi-persistent configuration of CCS resources through medium access control-control element (MAC-CE) and/or radio resource control (RRC), a second option associated with dynamic configuration of CCS resources via downlink control information (DCI), a third option associated with dynamic selection and reporting of CCS resources via physical uplink shared channel (PUSCH) symbol puncturing with a modulation and coding scheme (MCS) below a threshold (e.g. this option may be for the case where the WTRU overwrites (i.e., punctures) some PUSCH symbols, wherein the NW may have allocated an MCS lower than the reported channel quality indicator), and/or a fourth option associated with WTRU dynamic selection and reporting of CCS resources via allocated extra resources for CCS.

The processor may be configured to determine the CCS reporting mode out of the plurality of CCS reporting modes based on one or more of historical performance, channel condition, or peak-to-average power ratio (PAPR), power control parameters, and/or payload size of a generated CCS.

The historical performance may include, for example, the (e.g. highest) average historical downlink (DL) throughput, the (e.g., lowest) average historical DL block error rate (BLER), the (e.g., highest and/or lowest) compression rate, and/or (e.g. highest) average beamforming gain.

The channel condition may include, for example, channel measurements. The channel measurements may include, for example, one or more of rank indicator (RI), channel quality indicator (CQI), precoding matrix indicator (PMI), layer indicator (LI), CSI-RS resource indicator (CRI), reference signal received power (RSRP), signal-to-interference plus noise ratio (SINR), received signal strength indicator (RSSI), reference signal received quality (RSRQ), angle of arrival (AoA), area of departure (AoD), Doppler shift, Doppler spread, average delay, and/or delay spread.

The processor may be configured to generate the CCS symbols based on CSI-RS measurements based on a joint source channel compression and modulation (JSCCM) artificial intelligence or machine learning (AI/ML) model.

The processor may be configured to generate CSI feedback using a non-JSCCM CCS generator upon the condition that peak-to-average power ratio (PAPR) is above a threshold. When the PAPR is above the threshold, the processor may be configured to perform separate source channel coding (SSCC)-based CSI reporting and/or legacy precoding matrix indicator (PMI)-based CSI reporting based on the CSI feedback.

A WTRU may be configured to perform a method that includes one or more of the following steps. The method may include receiving configuration information. The configuration information may include, for example, an indication of a plurality of compressed channel state information (CSI) symbols (CCS) reporting modes, where each CCS reporting mode of the plurality of reporting modes may indicate a respective channel for reporting CCS symbols. The method may include determining a CCS reporting mode out of the plurality of CCS reporting modes. The method may include generating CCS symbols based on CSI reference signal (CSI-RS) measurements. The method may include determining a CCS reporting configuration based on the CCS reporting mode. The CCS reporting configuration may indicate, for example, resources of the channel associated with the CCS reporting mode. The method may include sending a report via the resources of the channel associated with the determined CCS reporting mode. The report may include, for example, the generated CCS symbols, the determined CCS reporting configuration, and/or the determined CCS reporting mode.

The plurality of CCS reporting modes may include, for example, two or more of a first mode associated with CCS multiplexed onto resources of a scheduled physical uplink shared channel (PUSCH) transmission, a second mode associated with CCS within a configurable physical uplink control channel (PUCCH) resource, and/or a third mode associated with a dedicated uplink channel for CCS.

The first mode may include, for example, a first option associated with a semi-persistent configuration of CCS resources through medium access control-control element (MAC-CE) and/or radio resource control (RRC), a second option associated with dynamic configuration of CCS resources via downlink control information (DCI), a third option associated with dynamic selection and reporting of CCS resources via physical uplink shared channel (PUSCH) symbol puncturing with a modulation and coding scheme (MCS) below a threshold (e.g. this option may be for the case where the WTRU overwrites (i.e., punctures) some PUSCH symbols, wherein the NW may have allocated an MCS lower than the reported channel quality indicator), and/or a fourth option associated with WTRU dynamic selection and reporting of CCS resources via allocated extra resources for CCS.

The method may include determining the CCS reporting mode out of the plurality of CCS reporting modes based on one or more of historical performance, channel condition, or peak-to-average power ratio (PAPR), power control parameters, and/or payload size of a generated CCS.

The historical performance may include, for example, the (e.g. highest) average historical downlink (DL) throughput, the (e.g., lowest) average historical DL block error rate (BLER), the (e.g., highest) compression rate, the (e.g., lowest) compression rate, and/or (e.g. highest) average beamforming gain.

The channel condition may include, for example, channel measurements. The channel measurements may include, for example, one or more of rank indicator (RI), channel quality indicator (CQI), precoding matrix indicator (PMI), layer indicator (LI), CSI-RS resource indicator (CRI), reference signal received power (RSRP), signal-to-interference plus noise ratio (SINR), received signal strength indicator (RSSI), reference signal received quality (RSRQ), angle of arrival (AoA), area of departure (AoD), Doppler shift, Doppler spread, average delay, and/or delay spread.

The method may include generating the CCS symbols based on CSI-RS measurements based on a joint source channel compression and modulation (JSCCM) artificial intelligence or machine learning (AI/ML) model.

The method may include generating CSI feedback using a non-JSCCM CCS generator upon the condition that peak-to-average power ratio (PAPR) is above a threshold. When the PAPR is above the threshold, the method may include performing separate source channel coding (SSCC)-based CSI reporting and/or legacy precoding matrix indicator (PMI)-based CSI reporting based on the CSI feedback.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example separate source channel coding (SSCC) end-to-end structure according to an embodiment.

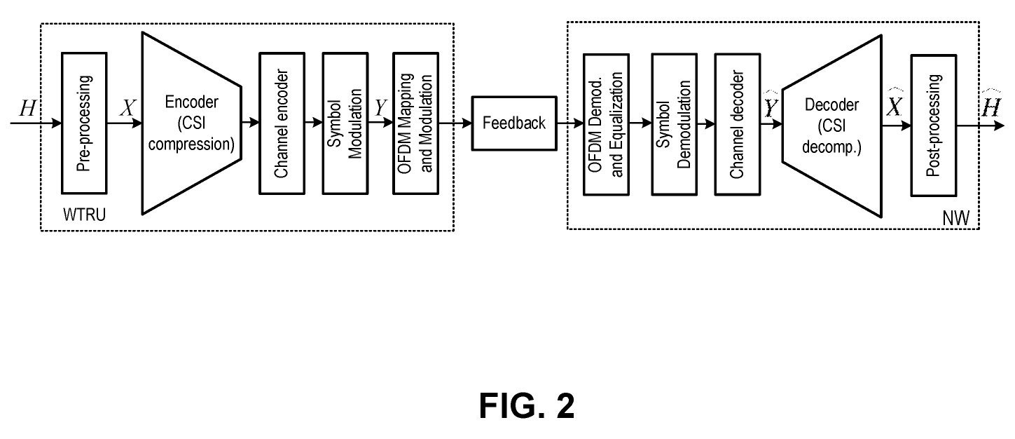

FIG. 3 is a system diagram illustrating an example joint source channel compression and modulation (JSCCM) end-to-end structure according to an embodiment.

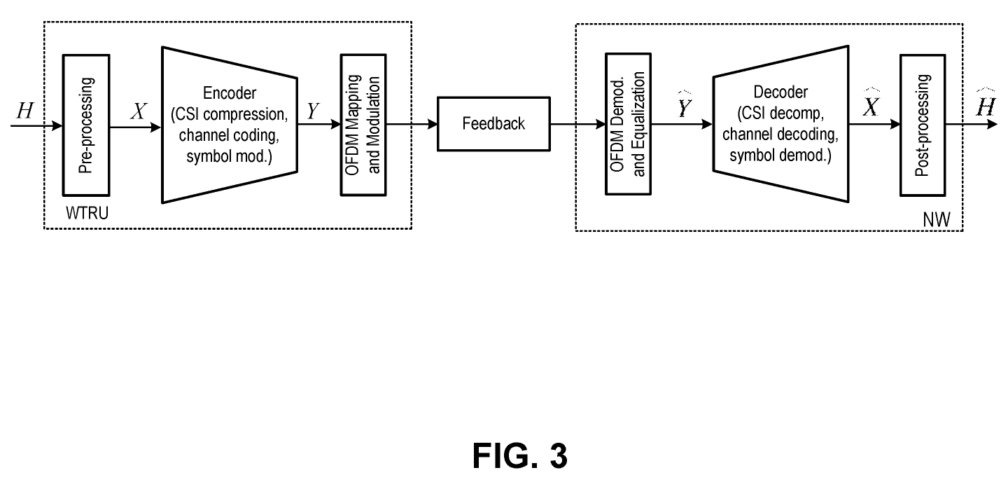

FIG. 4 is a system diagram illustrating example modes of compressed channel state information (CSI) symbols (CCS) reporting according to an embodiment.

FIG. 5 is a system diagram illustrating example CCS patterns according to an embodiment.

FIG. 6 is a flowchart illustrating an example procedure for JSCCM based CSI compression and/or feedback according to an embodiment.

### DETAILED DESCRIPTION

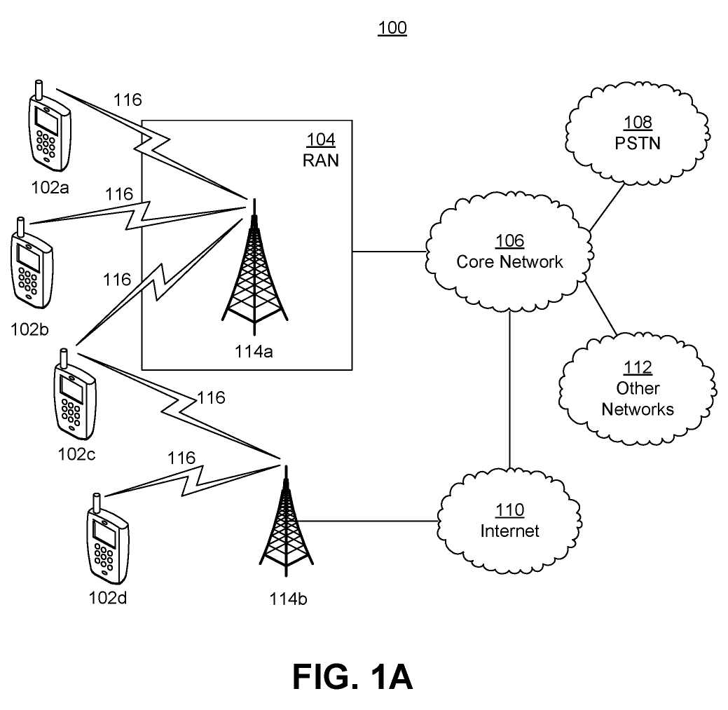

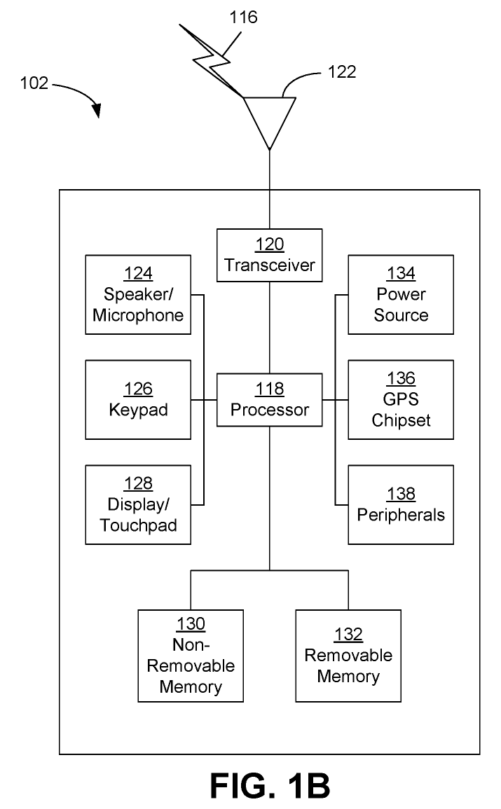

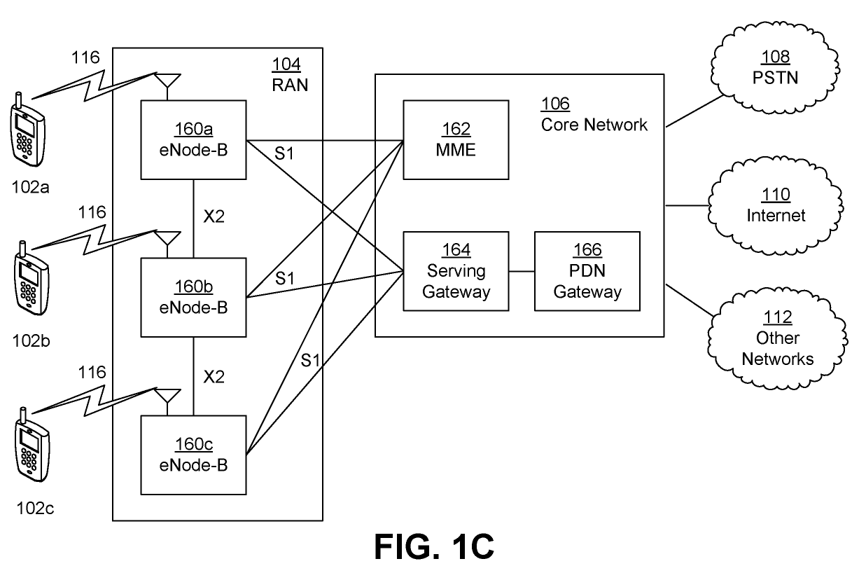

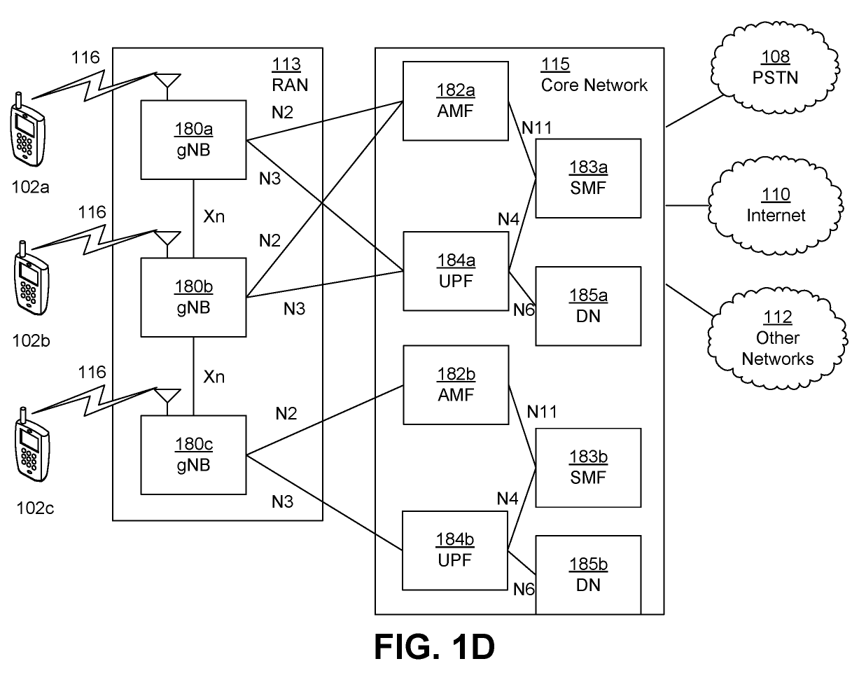

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160MHz wide channels. The 40 MHz, and/or 80 MHz, channels may be formed by combining contiguous 20 MHz channels. A 160MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be capable of joint source channel compression and modulation (JSCCM) based channel state information (CSI) feedback. A WTRU may receive CSI reference signals (CSI-RS) for channel measurement. A WTRU may compress the CSI using a JSCCM model and/or may obtain compressed CSI symbols (CCS). A WTRU may determine modes of CCS reporting. A WTRU may determine CCS resources based on a determined mode. A WTRU may report the CCS, the mode of reporting of CCS, and/or the determined CCS resources and/or configuration.

In some examples, a WTRU may be configured with one or more parameters associated with the operation of JSCCM based CSI compression and reporting, wherein the configuration may include one or more of the following. For example, the configuration may include a set of modes for reporting the compressed CSI symbols (CCS) (e.g., referred to as CCS reporting modes). For instance, the CCS reporting modes may include mode-1, wherein mode-1 is CCS multiplexed onto resources of a scheduled PUSCH transmission. Mode-1 may include options. For example, mode-1 option-1 may be a semi-persistent configuration of CCS resources through medium access control-control element (MAC-CE) and/or radio resource control (RRC). Mode-1 option-2 may be a dynamic configuration of CCS resources through downlink control information (DCI). Mode-1 option-3 may be the WTRU dynamically selecting and/or reporting CCS resources via PUSCH symbol puncturing with a lower modulation and coding scheme (MCS). Mode-1 option-4 may be the WTRU dynamically selecting and/or reporting CCS resources via allocated extra resources for CCS. Mode-2 may include CCS within a configurable and/or indicated PUCCH resource. Mode-3 may include a dedicated uplink channel for CCS.

The configuration may include multiplexing of CCS with other (e.g., legacy) CSI reporting. For example, multiplexing of CCS with other (e.g. legacy) CSI reporting may include channel quality indicator (CQI) and/or rank indicator (RI) within the input of JSCCM compression model. For example, multiplexing of CCS with other (e.g. legacy) CSI reporting may include CQI and/or RI in PUCCH associated with CCS feedback.

The configuration may include a pattern for mapping CCS reporting resources to OFDM grid. For example, the WTRU may be configured with a set of patterns for CCS reporting resources. The configuration may include a criteria for WTRU-based CCS reporting mode determination. The criteria may include, for example, thresholds on power control parameters, historical performance, channel conditions, signal-to-interference plus noise ratio (SINR), peak-to-average power ratio (PAPR), etc. The configuration may include configuration on the JSCCM model (e.g., model parameters, applicability conditions, etc.).

In some examples, the WTRU may determine the CCS reporting mode based on one or more of the following. For example, the CCS reporting mode may be determined by NW-based CCS reporting mode determination (e.g., based on NW configuration, semi-persistently through MAC-CE and/or RRC, and/or dynamically through each DCI.

For example, the CCS reporting mode may be determined by WTRU-based CCS reporting mode determination. WTRU-based CCS reporting mode determination may be based on, for example, historical performance (e.g., the WTRU may choose the mode resulting with the highest average historical DL throughput, and/or the lowest average historical DL block error rate (BLER), highest and/or lowest compression rate, and/or highest average beamforming gain, etc.). WTRU-based CCS reporting mode determination may be based on, for example, channel condition (e.g., if doppler spread is high, select mode-1, else mode-2 or 3). WTRU-based CCS reporting mode determination may be based on, for example, PAPR (e.g., if dedicated CCS channel PARP is lower than a threshold, then select mode-3, else select mode-1). WTRU-based CCS reporting mode determination may be based on, for example, power control parameters (e.g., if allocated power level is lower than a threshold, then select mode-1, else select mode-2 or mode-3). WTRU-based CCS reporting mode determination may be based on, for example, payload size of a generated CCS, and/or based on the compression rate. In some examples, the WTRU may determine to request reporting mode change from the NW if the WTRU determines a change of mode compared to previous reporting.

In some examples, the WTRU may receive CSI-RS for channel measurement. In some examples, the WTRU may compute the JSCCM based CSI feedback, (e.g., CCS symbols). In some examples, the WTRU may determine the JSCCM model based on the determined CCS reporting mode.

In some examples, the WTRU may determine CCS reporting configuration for the determined CCS reporting mode (e.g., resources, pattern, etc.) based on one or more of the following. For example, the WTRU may determine CCS reporting configuration for the determined CCS reporting mode based on NW configuration. For example, the WTRU may determine CCS reporting configuration for the determined CCS reporting mode based on WTRU-determined configuration. For instance, for mode-1 option-3, the WTRU may determine the CCS reporting resources for PUSCH puncturing (e.g., the WTRU replaces (e.g., punctures) the corresponding PUSCH symbols with the CCS symbols for one or more patterns in the set of configured CCS reporting patterns, and/or determines the CCS reporting pattern with lowest PAPR). For instance, for mode-1 option-4, the WTRU may determine the CCS reporting resources (e.g., OFDM symbol) for insertion within a set of allocated PUSCH symbols (e.g., the WTRU inserts CCS symbols in one or more OFDM symbols within the set of allocated PUSCH symbols, as per one or more patterns in the set of configured CCS reporting patterns, and/or may determine the CCS reporting pattern with lowest PAPR.

In some examples, the WTRU may determine to fallback to non-JSCCM based CSI reporting (e.g., legacy CSI reporting, and/or non-AI/ML based CSI reporting) based on one or more of the following. For example, the WTRU may determine to fallback to non-JSCCM based CSI reporting based on the PAPR being above a threshold for all the modes and/or options. For example, the WTRU may determine to fallback to non-JSCCM based CSI reporting based on channel and/or WTRU conditions do not generalize for the JSCCM model.

In some examples, the WTRU may report one or more of the following. For example, the WTRU may report a WTRU requested allocation of uplink resources to report CCS based on the determined mode. The WTRU may report the JSCCM based compressed CSI symbols (CCS) by mapping the compressed CSI symbols to time-frequency resources corresponding to the determined CCS reporting mode and/or determined CCS reporting configuration. The WTRU may report the determined CCS reporting mode. The WTRU may report the determined CCS reporting configuration and/or pattern (e.g., the determined pattern for mode-1 option-3 and/or option 4). The examples herein may describe methods and/or procedures for efficient CSI feedback with JSCCM-based compression that may minimize impairments, such as PAPR.

Methods for JSCCM based CSI compression and/or feedback may be implemented. Configurations on JSCCM based CSI compression and/or feedback may be implemented. In some examples, a WTRU may be configured with one or more two-sided JSCCM AI/ML models (e.g., autoencoder (AE)). The JSCCM model may perform joint CSI compression, channel coding, and/or symbol modulation. The encoder part associated with the JSCCM model may compress a high-dimensional CSI matrix and/or tensor to a low-dimensional latent representation, represented in complex symbols, wherein the symbols may be non-QAM based and/or may have any arbitrary constellation. The decoder part may reconstruct the CSI from the compressed complex symbols. The WTRU may be configured with one or more applicability conditions for the JSCCM model(s) activation, wherein the applicability conditions may include one or more of the following. For example, the applicability conditions may include one or more explicit configuration elements in the RCC signaling (e.g., in the CSI-MeasConfig). The applicability conditions may include one or more explicit configuration elements in MAC-CE (e.g., activation and/or deactivation of CSI resource sets). The applicability conditions may include explicit indication in a DCI field carrying CSI request (e.g., aperiodic or semi-persistent). The applicability conditions may include WTRU available computational resources when they are below a configured threshold.

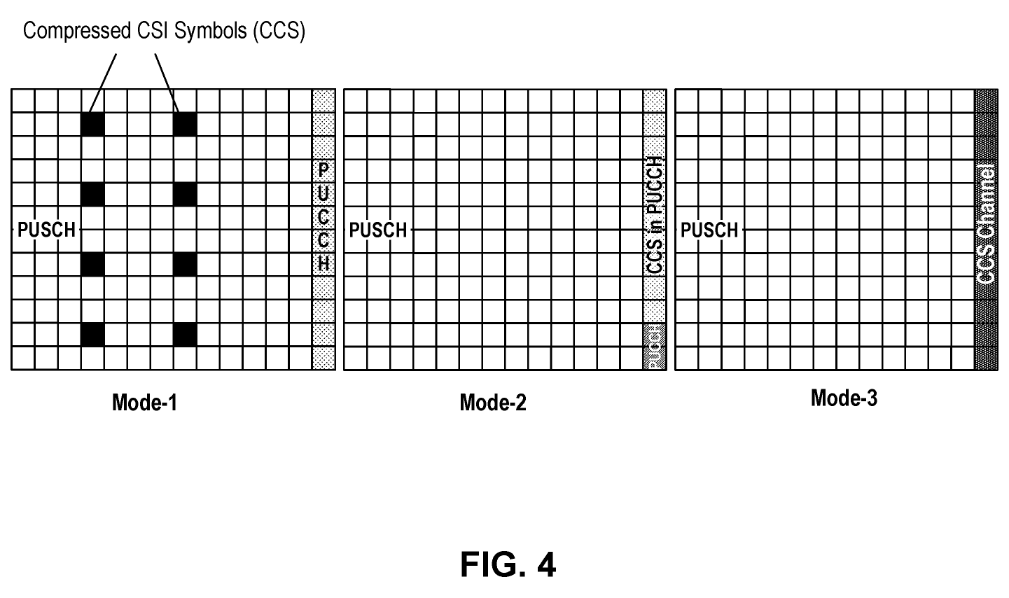

In some examples, the WTRU may be configured with a set of modes for reporting the output of the JSCCM encoder model, represented in complex valued symbols and/or referred to as compressed CSI symbols (CCS). As shown in FIG. 4, the JSCCM reporting modes may include a first mode, a second mode and a third mode. A first mode (e.g., Mode-1) may assume that the CCS are multiplexed onto resources of a scheduled PUSCH transmission. A second mode (e.g., Mode-2) may assume that the CCS are explicitly transmitted over a configurable and/or indicated PUCCH resource. A third mode (e.g., Mode-3) may assume that the WTRU may use a dedicated uplink channel for CCS transmission. For example, the NW may configure a CCS channel which is only dedicated for CCS transmission. The CCS channel may be configured through RRC signaling, MAC-CE and/or DCI signaling.

In some examples, the first mode (e.g., Mode-1) may further include multiple options for CCS reporting as follows. For example, in a first option (e.g., option-1) the reporting resources may be based on a semi-persistent configuration through RRC signaling (e.g., in CSI-MeasConfig and/or MAC-CE). In a second option (e.g., option-2) the reporting resources may be based on a dynamic configuration in a DCI indication. In a third option (e.g., option-3) the reporting resources may be based on selecting CCS resources via PUSCH symbol puncturing with a lower MCS, wherein the NW may allocate specific resource elements (REs) with lower MCS relative to other reported CSI quantities (e.g., CQI). The WTRU may replace and/or puncture some of those REs with CCS. In a forth option (e.g., option-4) the reporting resources may be dynamically selected based on an allocation of a set of extra resources for CCS.

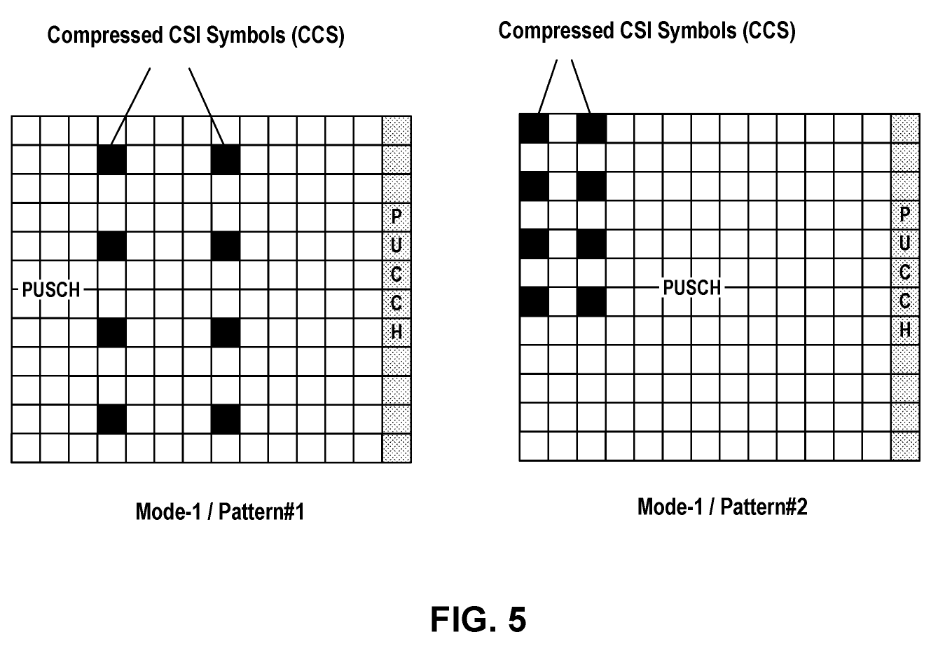

In some examples, the WTRU may be configured with a set of patterns for mapping CCS resources to OFDM grid, as shown in FIG. 5. The WTRU may be configured with a first pattern for mapping the data resources to the OFDM grid and a second pattern used specifically for mapping the CCS resources, wherein the first pattern and second pattern may be different.

In some examples, the WTRU may be configured with one or more criterions for determining the CCS reporting mode. For example, a first criteria may be based on power control parameters. The WTRU may be configured to select Mode-3 if the allocated power value for CCS is greater than a configured threshold. High power value may result in high PAPR which in turn may result in severe performance degradation under Mode-1 and/or Mode 2 as CCS are multiplexed with PDCCH symbols. In this example, selection of Mode-3 may be appropriate with high power values to deal with high PAPR scenarios. In some examples, the criteria to determine the CCS reporting mode may be based on the historical performance of the different modes across different scenarios. For example, the WTRU may be configured to update and/or switch the reporting mode if the average performance over a time period degrades below a threshold. In some examples, the criteria may be associated with a PAPR range, wherein the WTRU may determine the reporting mode based on the measured PAPR relation to one or more configure thresholds. In some examples, the criteria may be associated with one or more channel measurements. For example, the WTRU may be configured to determine the reporting mode based on measured Doppler spread compared against threshold. In some examples, the criteria may be associated with one or more measurements (e.g., SINR, signal-to-noise ration (SNR), and/or reference signal received power (RSRP)).

In some examples, the WTRU may be configured to multiplex CCS with other legacy CSI quantities (e.g., CQI and/or RI). For example, the WTRU may be configured to send CSI quantities (CQI and/or RI) along with the CCS feedback and its associated reporting mode. For example, for Mode-3 CCS reporting, the WTRU may be indicated to send the RI and/or CQI along with CCS on the CCS channel.

Determining the CCS reporting mode may be implemented. In some examples, a WTRU may be configured with a set of CCS reporting modes. A CCS reporting mode may be as described herein. In an example, a CCS reporting mode may reuse a CSI reporting configuration for non-CCS CSI reporting. In some examples, the WTRU may determine the CCS reporting mode to use for reporting one or more CCS reports. The WTRU may determine a CCS reporting mode and/or use it for a known and/or configurable number of CCS reports (e.g., one CCS reporting mode determination for each CCS report). The WTRU may determine and/or use a CCS reporting mode for all CCS reports until a subsequent determination of a new CCS reporting mode.

In some examples, the WTRU may be triggered to determine a CCS reporting mode, and/or parameters thereof, and/or may determine and/or select a CCS reporting mode, and/or parameters thereof, based on reception of an indication from gNB. For example, the WTRU may be configured to use and/or determine a CCS reporting mode via DCI, MAC-CE and/or RRC signaling. In another example, the WTRU may be triggered to use and/or determine a CCS reporting mode via signaling received from the gNB (e.g., via DCI, MAC-CE and/or RRC).

The indication may be an explicit indication (e.g., via a bitfield in a DCI, MAC-CE and/or RRC transmission). The indication may be an implicit indication (e.g., via reusing an existing bitfield in a DCI with a configuration to modify the interpretation of the existing bitfield). The indication may be received independently of a specific CCS reporting instance. For example, the indication may be for periodic CSI reporting and/or may be received in a transmission not associated with a specific CCS reporting instance. In another example, the indication may be associated with one or more specific CCS reporting instance. For example, the indication may be included in an aperiodic CSI request.

The indication may trigger periodic, aperiodic and/or semi-persistent determination of a CCS report mode. For example, periodic determination of CCS reporting mode may mean that at times determined by a periodicity and/or offset, the WTRU may determine a CCS reporting mode. For example, aperiodic determination of CCS reporting mode may mean that upon receiving the aperiodic trigger, the WTRU determines a CCS reporting mode. For example, semi-persistent determination of CCS reporting mode may mean that upon receiving a trigger, the WTRU may start and/or stop periodically determining a CCS reporting mode.

In some examples, a WTRU may receive from the gNB a configuration to trigger determination CSS reporting mode and/or to determine a CCS reporting mode. For example, the configuration may include one or more of the following. For example, the configuration may include a set of active and/or applicable CCS reporting modes. The configuration may include a CCS reporting mode priority. The configuration may include a CCS reporting mode determination threshold(s) and/or offset(s). The configuration may include a timing of determination of CCS reporting mode. The configuration may include a one or more triggers to determine a CCS reporting mode.

The WTRU may be triggered to determine a CCS reporting mode, and/or parameters thereof, and/or may determine and/or select a CCS reporting mode, and/or parameters thereof, based on one or more of the following. For instance, the WTRU may be triggered to determine a CCS reporting mode, and/or parameters thereof, and/or may determine and/or select a CCS reporting mode, and/or parameters thereof, based on channel conditions. For example, based on one or more channel measurements, the WTRU may select a CCS reporting mode. Where the one or more channel measurements may include at least one of: RI, CQI, precoding matrix indicator (PMI), layer indicator (LI), CSI-RS Resource Indicator (CRI), RSRP, SINR, received signal strength indicator (RSSI), reference signal received quality (RSRQ), angle of arrival (AoA), area of departure (AoD), Doppler shift, Doppler spread, average delay, and/or delay spread. For example, if the Doppler spread is higher than a threshold, the WTRU may select a first CCS reporting mode (e.g., mode 1).

For instance, the WTRU may be triggered to determine a CCS reporting mode, and/or parameters thereof, and/or may determine and/or select a CCS reporting mode, and/or parameters thereof, based on peak to average power ratio (PAPR). The WTRU may determine the PAPR of one or more candidate CCS reporting modes and/or may select the CCS reporting mode with the lowest PAPR. In another example, the WTRU may determine the PAPR and based on a comparison to a threshold, the WTRU may select a CCS reporting mode. For example, If the PAPR (e.g., the PAPR when using mode-3) is lower than a threshold, then the WTRU may select CCS reporting mode-3; otherwise, the WTRU may select CCS reporting mode-1. The PAPR determination may be for a single CCS reporting instance and/or may be an average value over multiple CCS reporting instances.

For instance, the WTRU may be triggered to determine a CCS reporting mode, and/or parameters thereof, and/or may determine and/or select a CCS reporting mode, and/or parameters thereof, based on UL power control. For example, the WTRU may determine a CCS reporting mode based on the configured and/or determined UL power of the transmission that includes the CCS report. For example, if the UL transmission power is less than a threshold, the WTRU may select CCS reporting mode-1; otherwise, the WTRU may select either CCS reporting mode-2 and/or mode-3.

For instance, the WTRU may be triggered to determine a CCS reporting mode, and/or parameters thereof, and/or may determine and/or select a CCS reporting mode, and/or parameters thereof, based on transmission performance. For example, the WTRU may select a reporting mode based on DL throughput (e.g., historical DL throughput, and/or DL throughput achieved in a set of DL transmissions), and/or hybrid automatic repeat request (HARQ)-negative acknowledgement (NACK) rate (e.g., rate of HARQ-NACK in a set of DL transmissions), and/or average DL BLER (e.g., where the average is performed over a set of DL transmissions). The set of DL transmissions over which the transmission performance may be evaluated may be a fixed number of transmissions (e.g., n most recent DL transmissions). In another example, the set of DL transmissions may be determined by a window of duration, where the window timing may be determined based on the CCS reporting mode determination timing and/or the CCS reporting instance.

For instance, the WTRU may be triggered to determine a CCS reporting mode, and/or parameters thereof, and/or may determine and/or select a CCS reporting mode, and/or parameters thereof, based on CCS compression rate. For example, the WTRU may be triggered to determine a CCS reporting mode and/or may determine and/or select a CCS reporting mode based on the compression rate of one or more CCS reports, possibly compared to a threshold and/or offset.

For instance, the WTRU may be triggered to determine a CCS reporting mode, and/or parameters thereof, and/or may determine and/or select a CCS reporting mode, and/or parameters thereof, based on CCS report payload size. For example, the WTRU may be triggered to determine a CCS reporting mode and/or may determine and/or select a CCS reporting mode based on the CCS report payload of one or more CCS report instances.

For instance, the WTRU may be triggered to determine a CCS reporting mode, and/or parameters thereof, and/or may determine and/or select a CCS reporting mode, and/or parameters thereof, based on whether the WTRU is scheduled with an UL transmission (e.g., data transmission) in the symbols and/or slots and/or subframes where the CCS report is to be transmitted. For example, if the WTRU is scheduled with a PUSCH transmission in the same symbols as the CCS report instance, the WTRU may select a first mode. In another example, if the WTRU is configured with PUCCH resources in the same symbols as the CCS report instance, the WTRU may select a second or third mode. In an example, the WTRU may determine the CCS reporting mode based on whether the CCS reporting occurs on dynamically scheduled UL resources of semi-statically configured UL resources (e.g., configured grant resources).

For instance, the WTRU may be triggered to determine a CCS reporting mode, and/or parameters thereof, and/or may determine and/or select a CCS reporting mode, and/or parameters thereof, based on whether the WTRU is configured with simultaneous PUSCH transmission-CCS reporting capability or not.

For instance, the WTRU may be triggered to determine a CCS reporting mode, and/or parameters thereof, and/or may determine and/or select a CCS reporting mode, and/or parameters thereof, based on the priority of the CCS report and/or the priority of another transmission. For example, the WTRU may determine a CCS reporting mode based on the priority of the CCS report. In another example, the WTRU may determine a CCS reporting mode based on the priority of the CCS report and/or the priority of another transmission (e.g., PUSCH) occurring in the same symbols and/or slots and/or subframes. For example, if the priority of the CCS report is high, the WTRU may always select a first CCS reporting mode. If the priority of the CCS report is low, then the WTRU may determine the CCS reporting mode as a function of whether a second transmission is scheduled to occur in the same resources and/or the priority of the second transmission.

For instance, the WTRU may be triggered to determine a CCS reporting mode, and/or parameters thereof, and/or may determine and/or select a CCS reporting mode, and/or parameters thereof, based on the transmission status of a previous CCS reporting instance. For example, the WTRU may be triggered to determine, and/or may determine to use, a CCS reporting mode based on whether it dropped a previous CCS reporting instance. Where a WTRU may drop a CCS reporting instance due to one or more of: collision with transmission of higher priority, failed channel access (e.g., listen-before-talk (LBT)), and/or pre-emption. In another example, the WTRU may determine to use a CCS reporting mode based on the CCS reporting mode used and/or determined for a previous CCS reporting instance.

For instance, the WTRU may be triggered to determine a CCS reporting mode, and/or parameters thereof, and/or may determine and/or select a CCS reporting mode, and/or parameters thereof, based on the compression model used. For example, the WTRU may determine a CCS reporting mode based on the AI/ML compression model being used.

For instance, the WTRU may be triggered to determine a CCS reporting mode, and/or parameters thereof, and/or may determine and/or select a CCS reporting mode, and/or parameters thereof, based on the type of measurements being reported. For example, the WTRU may determine a CCS reporting mode based on the type of measurements being reported, where the type of measurements may include one or more of: measurements for CSI feedback, measurements for beam management, measurements for positioning, and/or measurements for data collection. The type of measurements may also include one or more of: RI, CQI, PMI, LI, CRI, RSRP, SINR, RSSI, RSRQ, AoA, AoD, Doppler shift, Doppler spread, average delay, delay spread, wideband measurements, and/or subband measurements.

For instance, the WTRU may be triggered to determine a CCS reporting mode, and/or parameters thereof, and/or may determine and/or select a CCS reporting mode, and/or parameters thereof, based on previously selected and/or used CCS reporting mode. For example, a WTRU may be triggered to determine a new CCS reporting mode if it previously used a first CCS reporting mode.

For instance, the WTRU may be triggered to determine a CCS reporting mode, and/or parameters thereof, and/or may determine and/or select a CCS reporting mode, and/or parameters thereof, based on determined and/or used CCS reporting mode for another CCS report instance. For example, a WTRU may determine a CCS reporting mode to be used in a first set of frequency and/or time and/or beam resources (e.g., in a first bandwidth part) based on the CCS reporting mode selected and/or used in a second set of frequency and/or time and/or beam resources (e.g., in a second bandwidth part).

For instance, the WTRU may be triggered to determine a CCS reporting mode, and/or parameters thereof, and/or may determine and/or select a CCS reporting mode, and/or parameters thereof, based on type of CSI feedback. For example, the WTRU may be triggered to determine or may determine a CCS reporting mode based on whether the CSI feedback is periodic, aperiodic, and/or semi-persistent.

For instance, the WTRU may be triggered to determine a CCS reporting mode, and/or parameters thereof, and/or may determine and/or select a CCS reporting mode, and/or parameters thereof, based on resources used for CCS reporting. For example, the WTRU may determine a CCS reporting mode based on the timing and/or physical resource blocks (PRBs) and/or beam used for the transmission of one or more CCS reports. For example, the WTRU may determine a CCS reporting mode based on whether the resources of the CCS reporting mode overlap specific REs (e.g., REs used for reference signals).

For instance, the WTRU may be triggered to determine a CCS reporting mode, and/or parameters thereof, and/or may determine and/or select a CCS reporting mode, and/or parameters thereof, based on reception of an indication. For example, the WTRU may receive an indication from the gNB to trigger a determination of a CCS reporting mode, and/or to change the determined CCS reporting mode.

Computing the JSCCM based CSI feedback may be implemented. In some examples, the WTRU receives CSI-RS for channel measurements according to the CSI-RS configuration, and performs channel estimation. The input to the JSCCM model may be the estimated channel and the output of the model may be the compressed representation of the channel. In another example, the input to the model may be a predicted channel corresponding to future time instances.

In some examples, the WTRU may be equipped with a set of different AI/ML models for JSCCM and/or determines and/or computes the CCS output symbols according to the model configuration (e.g., JSCCM model parameters) and/or applicability conditions. In one example, the WTRU may select a suitable AI/ML model (e.g., the JSCCM model that aligns more with the configured JSCCM parameters). In another example, the WTRU may select and/or activate a JSCCM model that matches the set of configured applicability conditions.

For example, the WTRU may perform the JSCCM model selection based on one or more of the following. For instance, the WTRU may perform the JSCCM model selection based on the configured distortion and/or compression ratio. For example, WTRU may select the model that provides better performance for a configured compression ratio. For instance, the WTRU may perform the JSCCM model selection based on the payload size. For example, the WTRU may select a AI/ML model compatible with the payload size (e.g., the hardware configuration) of the CSI feedback. For instance, the WTRU may perform the JSCCM model selection based on a specific pre-processing function. For example, The WTRU may select a JSCCM model according to the configured pre-processing function (e.g., raw domain, Eigen Vector (EV) domain, bandwidth delay product (BDP)). For instance, the WTRU may perform the JSCCM model selection based on the channel condition. For example, the WTRU may estimate the number of channel errors of the compressed feedback based on channel conditions, and may select a JSCCM model according to the correction capacity of the JSCCM model. For instance, the WTRU may perform the JSCCM model selection based on statistical input distribution. For example, WTRU may perform some statistical measurements on the model input (e.g., first-order statistics, correlation, out-of-distribution (OOD) detection, etc.). In this example, the WTRU selects a JSCCM model that aligns with the measured input distribution. For instance, the WTRU may perform the JSCCM model selection based on the configured bit per symbol of the constellation mapping. For example, the WTRU may select a JSCCM model according to the configured number of bits per symbol for constellation shaping. For instance, the WTRU may perform the JSCCM model selection based on one or more applicability condition(s). For example, the WTRU may select a JSCCM model based on its AI/ML model training information (e.g., applicable conditions considered for model training), such as, WTRU speed, Doppler, coherence time, time-domain channel property (TDCP), etc.

In some examples, the WTRU may determine a set of JSCCM models to activate based on complexity requirements, and one or more criteria and/or conditions in the list above. For example, the WTRU may select an AI/ML that requires less complexity (e.g., floating-point operations per second (FLOPs) and/or CPUs), and/or less latency. In another example, the WTRU may select a AI/ML model for JSCCM that optimizes the performance and/or complexity trade-off according to some pre-configured thresholds and/or rules. In another example, the WTRU may perform the selection of a AI/ML model capable of JSCCM based on the determined mode of reporting for CCS. For example, if the determined CCS reporting mode is Mode 1, the WTRU may select a JSCCM model that perform above a configured performance threshold when Doppler spread is high. In another example, if Mode 2 or Mode 3 are selected, the WTRU selects a JSCCM model suitable for low Doppler spread, and/or a model suitable for high allocated power level. In a different example, if Mode 1 is determined, then the WTRU may select a model suitable for low allocated power. In another example, if Mode 1 is selected, the WTRU may select a model suitable for high PAPR. Another example is when Mode 3 is determined, the WTRU may select a JSCCM model that performs well (e.g., above a performance threshold) when the dedicated CCS channel PAPR is low.

Determining CCS reporting configuration and/or resources and determining fallback may be implemented. In some examples, the WTRU may determine the CCS configuration (e.g., resources and/or pattern) after the determination of mode of reporting and/or computing the compressed CSI feedback with JSCCM based compression model. The WTRU may determine the CCS reporting configuration based on the following options. For example, the WTRU may determine the CCS reporting configuration based on NW configured determination of CCS reporting resources. For instance, the NW may configure the WTRU with the time frequency resources and/or pattern for the reporting of CCS. The CCS configuration may depend on the determined mode of CCS reporting. For mode1, the NW may indicate the reporting pattern/resources for multiplexing the PUSCH symbols with CCS. For mode 2, for example, the NW may indicate the reporting pattern and/or resources for multiplexing the PUCCH symbols with CCS. For mode 3, for example, the NW may indicate the reporting pattern and/or resources for reporting the CCS feedback (e.g., through a dedicated CCS channel). The dedicated CCS channel may be configured via DCI, MAC-CE and/or RRC signaling. In an example, the NW may indicate an index corresponding to the pattern and/or resources for the WTRU to select from a codebook of patterns and/or resources.

For example, the WTRU may determine the CCS reporting configuration based on the WTRU determined CCS reporting configurations. For instance, for mode-1 option-3, the WTRU may determine CCS resources and/or pattern for RE-based (e.g., symbol-based) puncturing. Example patterns are provided in FIG. 5 wherein 2 patterns are provided as an example. In this option, the WTRU may be configured with a lower MCS value compared to the reported CQI to allow for better error recovery performance at the NW. In this option, the WTRU may determine a subset of PUSCH RE resources in OFDM grid to puncture (e.g., over-write) and replace the determined PUSCH REs with CCS symbols. The number of CCS symbols may be configured by the NW as the output dimension of JSCCM model. For example, the WTRU may determine the puncturing resources (e.g., locations of CCS resources in FIG. 5) such that the final PAPR is minimized when the puncturing resources in PUSCH are replaced with CCS symbols. In an example, the WTRU may be configured with a set of patterns for CCS resources, and the WTRU may determine the index of CCS pattern that results in lowest PAPR in the OFDM grid of multiplexed CCS and/or PUSCH. The WTRU may compute parp_1, the average PAPR for PUSCH multiplexed with CCS pattern#1 puncturing, and papr_2, the average PAPR for PUSCH multiplexed with CCS pattern#2 puncturing, and then chose the pattern with lowest PARP. For example, the WTRU may determine the puncturing resources such that the distance between the PUSCH symbols in the pattern and the CCS symbols may be minimized. In an example, the WTRU may be configured with a set of patterns for CCS resources, and the WTRU may determine the index of CCS pattern that results in lowest difference between PUSCH symbols and/or CCS for the corresponding pattern. The WTRU may compute a distance_1, the distance between original PUSCH symbols and PUSCH multiplexed with CCS pattern#1 puncturing, and distance_2, the distance between original PUSCH symbols and the PUSCH multiplexed with CCS pattern#2 puncturing. Then, the WTRU may choose the pattern with lowest distance.

For mode-1 option-4, the WTRU may determine CCS resources and/or patterns for symbol insertion in OFDM grid within a set of determined PUSCH symbols. In this option, the WTRU may be configured with additional resources (e.g., REs) wherein the number of additional resources may be equal to the number of CCS symbols (e.g., the output dimension of JSCCM encoder). The number of additional resources may be configured with the configuration of JSCCM model output size. In this option, the WTRU inserts the CCS symbols in between the determined PUSCH symbols. For instance, the WTRU may determine the CCS resources such the average PAPR may be minimized when the CCS symbols are inserted. In an example, the WTRU may be configured with a set of patterns for CCS resources, and the WTRU may determine the index of CCS pattern that results in lowest PAPR in the OFDM grid of multiplexed CCS and/or PUSCH. The WTRU may compute papr_1, the average PARP for PUSCH multiplexed with CCS pattern#1 insertion, and papr_2, the average PAPR for PUSCH multiplexed with CCS pattern#2 insertion, and then chose the one with lowest PAPR.

In some examples, the WTRU may evaluate the fallback conditions based on one or more of the following. For example, the WTRU may evaluate the fallback conditions by comparing the PAPR value of the determined mode against the configured thresholds. If the PAPR value of the determined mode is higher than a threshold, then the WTRU may request fallback to SSCC-based CSI reporting and/or legacy PMI-based CSI reporting. The WTRU may evaluate the fallback conditions by comparing the PAPR value of the determined PUSCH/CCS multiplexed configuration for Mode-1 Option-3 and/or 4 against the configured thresholds. If the PAPR value is higher than a threshold, then the WTRU may request fallback to SSCC-based CSI reporting and/or legacy PMI-based CSI reporting. The WTRU may evaluate the fallback conditions based on the channel conditions (e.g., doppler and/or line of sight (LOS)/non-LOS (NLOS)). If the WTRU determines that the current channel conditions do not generalize to the configured JSCCM model, then the WTRU may determine fallback. The WTRU may evaluate the fallback conditions based on the WTRU condition (e.g., WTRU speed). If the WTRU determines that the WTRU channel conditions do not generalize to the configured JSCCM model, then the WTRU may determine fallback. The WTRU may evaluate the fallback conditions based on the scenario (e.g., indoor and/or outdoor). If the WTRU determines that JSCCM model does not support the current scenario, then the WTRU may determine fallback.

Reporting CCS may be implemented. In some examples, the WTRU may transmit one or more additional information associated with a CCS feedback transmission. Additional information may include one or more of the following. For example, additional information may include type of CSI feedback (e.g., legacy CSI feedback, CCS feedback and/or hybrid feedback). Additional information may include if CCS feedback is used, then the resources used for CCS feedback. Additional information may include the pattern and/or location and/or density of resources used for CCS feedback. Additional information may include the reporting mode for CCS feedback, the reporting format of CCS feedback, and/or the preprocessing applied to the CCS feedback. Additional information may include implicit and/or explicit identity of AI model and/or functionality associated with CCS feedback transmission. Additional information may include the CSI reporting quantity, the CSI reporting configuration, post processing applied to CCS feedback (e.g., quantization), and/or WTRU side conditions (e.g., speed, channel condition) applicable for CCS feedback, etc.

The WTRU may determine the CSI reporting mode configuration based on one or more methods described above and herein. In an example, the UL resources for transmission of CCS feedback may be a function of the reporting mode. In an example, the WTRU may request for UL resources to report CCS based on determined reporting mode.

In some examples, in a first reporting mode (e.g., JSCCM reporting mode-1), the WTRU may transmit CCS feedback multiplexed with a scheduled PUSCH resource. For example, the WTRU may transmit CCS feedback in the UL resources preconfigured based on semi-persistent configuration. For example, the WTRU may transmit CCS feedback in the UL resources dynamically indicated in a DCI. For example, the WTRU may transmit CCS feedback in the UL resources by puncturing one or more REs. In an example, the WTRU may map the CCS feedback to UL resource based on a preconfigured pattern. In a second reporting mode (e.g., JSCCM reporting mode-2), the WTRU may transmit the CCS feedback in a preconfigured PUCCH resource. The WTRU may be configured to transmit CCS feedback in a first PUCCH resource. The WTRU may be configured to transmit legacy CSI feedback in a second PUCCH resource. In an example, the WTRU may transmit a first subset of CSI reporting quantities (e.g., CQI and/or RI) using legacy CSI feedback and/or second subset of CSI report quantities (e.g., CSI, CQI, and/or RI) using CCS feedback. In a third reporting mode (e.g., JSCCM reporting mode-3), the WTRU may be configured with a dedicated UL channel for CCS transmission. The WTRU may receive such configuration in a RRC signaling. The WTRU may receive such configuration via activation signaling in MAC-CE.

In some examples, the WTRU may transmit additional information associated with CCS feedback along with the CCS feedback. For example, the WTRU may transmit the additional information and the CCS feedback in the same PUCCH resource. In another example, the WTRU may transmit the additional information in a first PUCCH resource and the CCS feedback in a second PUCCH resource. In another example, the WTRU may transmit the additional information and CCS feedback in separate transmission. For example, the WTRU may transmit the additional information in PUCCH symbols and the CCS feedback in the CCS symbols preconfigured for CCS transmission.

In some examples, the WTRU may transmit additional information in uplink control information. In an example, the WTRU may transmit the additional information in a MAC-CE. Such transmission may be periodic, semi-persistent and/or event triggered. For example, the WTRU may transmit additional information upon a change in CCS reporting mode. In an example, the WTRU may request for resources to transmit the additional information. For example, the WTRU may be configured to trigger scheduling request (SR) to request resources for transmitting additional information. In another example, the WTRU may be configurated with a plurality of SR resources, wherein each SR resource may be associated with an additional information (e.g., JSCCM reporting mode). The WTRU may implicitly indicate the additional information based on selection and transmission of SR on the preconfigured resource associated with that additional information.

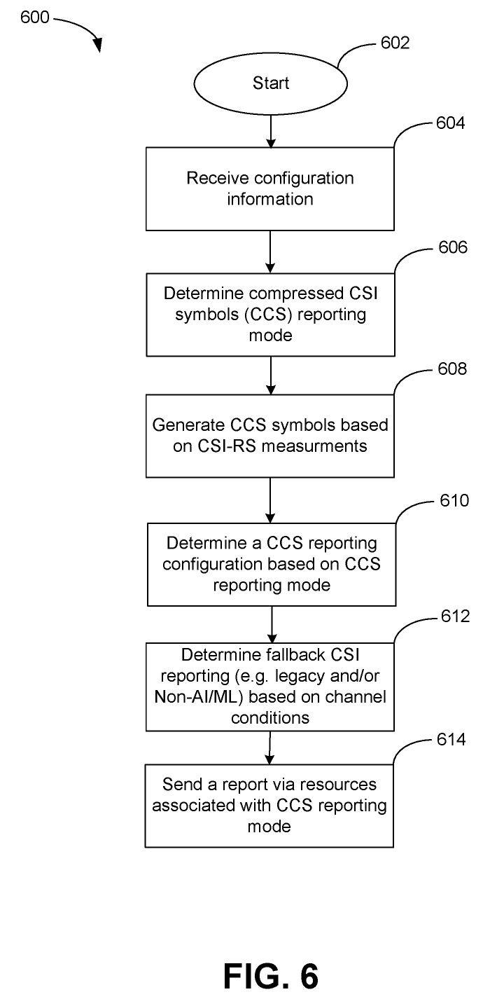

FIG. 6 is an example of a procedure 600 for JSCCM based CSI compression and/or feedback. The procedure 600 may be performed by a WTRU. The procedure 600 may be start at 602. At 604, the WTRU may receive configuration information. A WTRU may be configured with one or more parameters associated with the operation of JSCCM based CSI compression and reporting, wherein the configuration may include one or more of the following. For example, the configuration may include a set of modes for reporting the compressed CSI symbols (CCS) (e.g., referred to as CCS reporting modes). For instance, the CCS reporting modes may include mode-1, wherein mode-1 is CCS multiplexed onto resources of a scheduled PUSCH transmission. Mode-1 may include options. For example, mode-1 option-1 may be a semi-persistent configuration of CCS resources through medium access control-control element (MAC-CE) and/or radio resource control (RRC). Mode-1 option-2 may be a dynamic configuration of CCS resources through downlink control information (DCI). Mode-1 option-3 may be the WTRU dynamically selecting and/or reporting CCS resources via PUSCH symbol puncturing with a lower modulation and coding scheme (MCS). Mode-1 option-4 may be the WTRU dynamically selecting and/or reporting CCS resources via allocated extra resources for CCS. Mode-2 may include CCS within a configurable and/or indicated PUCCH resource. Mode-3 may include a dedicated uplink channel for CCS. The configuration may include multiplexing of CCS with other (e.g., legacy) CSI reporting. For example, multiplexing of CCS with other (e.g. legacy) CSI reporting may include channel quality indicator (CQI) and/or rank indicator (RI) within the input of JSCCM compression model. For example, multiplexing of CCS with other (e.g. legacy) CSI reporting may include CQI and/or RI in PUCCH associated with CCS feedback. The configuration may include a pattern for mapping CCS reporting resources to OFDM grid. For example, the WTRU may be configured with a set of patterns for CCS reporting resources. The configuration may include a criteria for WTRU-based CCS reporting mode determination. The criteria may include, for example, thresholds on power control parameters, historical performance, channel conditions, signal-to-interference plus noise ratio (SINR), peak-to-average power ratio (PAPR), etc. The configuration may include configuration on the JSCCM model (e.g., model parameters, applicability conditions, etc.).

At 606, the WTRU may determine the CCS reporting mode based on one or more of the following. For example, the CCS reporting mode may be determined by NW-based CCS reporting mode determination (e.g., based on NW configuration, semi-persistently through MAC-CE and/or RRC, and/or dynamically through each DCI. For example, the CCS reporting mode may be determined by WTRU-based CCS reporting mode determination. WTRU-based CCS reporting mode determination may be based on, for example, historical performance (e.g., the WTRU may choose the mode resulting with the highest average historical DL throughput, and/or the lowest average historical DL block error rate (BLER), highest and/or lowest compression rate, and/or highest average beamforming gain, etc.). WTRU-based CCS reporting mode determination may be based on, for example, channel condition (e.g., if doppler spread is high, select mode-1, else mode-2 or 3). WTRU-based CCS reporting mode determination may be based on, for example, PAPR (e.g., if dedicated CCS channel PARP is lower than a threshold, then select mode-3, else select mode-1). WTRU-based CCS reporting mode determination may be based on, for example, power control parameters (e.g., if allocated power level is lower than a threshold, then select mode-1, else select mode-2 or mode-3). WTRU-based CCS reporting mode determination may be based on, for example, payload size of a generated CCS, and/or based on the compression rate. In some examples, the WTRU may determine to request reporting mode change from the NW if the WTRU determines a change of mode compared to previous reporting.

At 608, the WTRU may receive CSI-RS for channel measurement. In some examples, the WTRU may compute the JSCCM based CSI feedback, (e.g., CCS symbols). In some examples, the WTRU may determine the JSCCM model based on the determined CCS reporting mode.

At 610, the WTRU may determine CCS reporting configuration for the determined CCS reporting mode (e.g., resources, pattern, etc.) based on one or more of the following. For example, the WTRU may determine CCS reporting configuration for the determined CCS reporting mode based on NW configuration. For example, the WTRU may determine CCS reporting configuration for the determined CCS reporting mode based on WTRU-determined configuration. For instance, for mode-1 option-3, the WTRU may determine the CCS reporting resources for PUSCH puncturing (e.g., the WTRU replaces (e.g., punctures) the corresponding PUSCH symbols with the CCS symbols for one or more patterns in the set of configured CCS reporting patterns, and/or determines the CCS reporting pattern with lowest PAPR). For instance, for mode-1 option-4, the WTRU may determine the CCS reporting resources (e.g., OFDM symbol) for insertion within a set of allocated PUSCH symbols (e.g., the WTRU inserts CCS symbols in one or more OFDM symbols within the set of allocated PUSCH symbols, as per one or more patterns in the set of configured CCS reporting patterns, and/or may determine the CCS reporting pattern with lowest PAPR.

At 612, the WTRU may determine to fallback to non-JSCCM based CSI reporting (e.g., legacy CSI reporting, and/or non-AI/ML based CSI reporting) based on one or more of the following. For example, the WTRU may determine to fallback to non-JSCCM based CSI reporting based on the PAPR being above a threshold for all the modes and/or options. For example, the WTRU may determine to fallback to non-JSCCM based CSI reporting based on channel and/or WTRU conditions do not generalize for the JSCCM model.

At 614, the WTRU may report one or more of the following. For example, the WTRU may report a WTRU requested allocation of uplink resources to report CCS based on the determined mode. The WTRU may report the JSCCM based compressed CSI symbols (CCS) by mapping the compressed CSI symbols to time-frequency resources corresponding to the determined CCS reporting mode and/or determined CCS reporting configuration. The WTRU may report the determined CCS reporting mode. The WTRU may report the determined CCS reporting configuration and/or pattern (e.g., the determined pattern for mode-1 option-3 and/or option 4).

1. A wireless transmit/receive unit (WTRU) comprising:
a processor configured to:
receive configuration information, wherein the configuration information indicates a plurality of compressed channel state information (CSI) symbols (CCS) reporting modes, wherein each CCS reporting mode of the plurality of CCS reporting modes indicates a respective channel for reporting CCS symbols;
determine a CCS reporting mode out of the plurality of CCS reporting modes;
generate CCS symbols based on CSI reference signal (CSI-RS) measurements;
determine a CCS reporting configuration based on the CCS reporting mode, wherein the CCS reporting configuration indicates resources of the respective channel associated with the CCS reporting mode; and
send a report via the resources of the respective channel associated with the determined CCS reporting mode.

2. The WTRU of claim 1, wherein the plurality of CCS reporting modes comprises two or more of a first mode associated with CCS multiplexed onto resources of a scheduled physical uplink shared channel (PUSCH) transmission, a second mode associated with CCS within a configurable physical uplink control channel (PUCCH) resource, or a third mode associated with a dedicated uplink channel for CCS.

3. The WTRU of claim 2, wherein the first mode comprises a first option associated with a semi-persistent configuration of CCS resources through medium access control-control element (MAC-CE) or radio resource control (RRC), a second option associated with dynamic configuration of CCS resources via downlink control information (DCI), a third option associated with dynamic selection and reporting of CCS resources via physical uplink shared channel (PUSCH) symbol puncturing with a modulation and coding scheme (MCS) below a threshold, and a fourth option associated with WTRU dynamic selection and reporting of CCS resources via allocated extra resources for CCS.

4. The WTRU of claim 1, wherein the processor is configured to determine the CCS reporting mode out of the plurality of CCS reporting modes based on one or more of historical performance, channel condition, or peak-to-average power ratio (PAPR), power control parameters, or payload size of a generated CCS.

5. The WTRU of claim 4, wherein the historical performance comprises average historical downlink (DL) throughput, average historical DL block error rate (BLER), compression rate, or average beamforming gain.

6. The WTRU of claim 4, wherein the channel condition comprises channel measurements, wherein the channel measurements comprises one or more of rank indicator (RI), channel quality indicator (CQI), precoding matrix indicator (PMI), layer indicator (LI), CSI-RS resource indicator (CRI), reference signal received power (RSRP), signal-to-interference plus noise ratio (SINR), received signal strength indicator (RSSI), reference signal received quality (RSRQ), angle of arrival (AoA), area of departure (AoD), Doppler shift, Doppler spread, average delay, or delay spread.

7. The WTRU of claim 1, wherein the processor is configured to generate the CCS symbols based on CSI-RS measurements based on a joint source channel compression and modulation (JSCCM) artificial intelligence or machine learning (AI/ML) model.

8. The WTRU of claim 1, wherein the processor is further configured to generate CSI feedback using a non-JSCCM CCS generator upon the condition that peak-to-average power ratio (PAPR) is above a threshold.

9. The WTRU of claim 8, wherein, when the PAPR is above the threshold, the processor is configured to perform separate source channel coding (SSCC)-based CSI reporting or legacy precoding matrix indicator (PMI)-based CSI reporting based on the CSI feedback.

10. The WTRU of claim 1, wherein the report comprises the generated CCS symbols, the determined CCS reporting configuration, and the determined CCS reporting mode.

11. A method performed by a wireless transmit/receive unit (WTRU), the method comprising:
receiving configuration information, wherein the configuration information indicates a plurality of compressed channel state information (CSI) symbols (CCS) reporting modes, wherein each CCS reporting mode of the plurality of CCS reporting modes indicates a respective channel for reporting CCS symbols;
determining a CCS reporting mode out of the plurality of CCS reporting modes;
generating CCS symbols based on CSI reference signal (CSI-RS) measurements;
determining a CCS reporting configuration based on the CCS reporting mode, wherein the CCS reporting configuration indicates resources of the respective channel associated with the CCS reporting mode; and
sending a report via the resources of the respective channel associated with the determined CCS reporting mode.

12. The method of claim 11, wherein the plurality of CCS reporting modes comprises two or more of a first mode associated with CCS multiplexed onto resources of a scheduled physical uplink shared channel (PUSCH) transmission, a second mode associated with CCS within a configurable physical uplink control channel (PUCCH) resource, or a third mode associated with a dedicated uplink channel for CCS.

13. The method of claim 12, wherein the first mode comprises a first option associated with a semi-persistent configuration of CCS resources through medium access control-control element (MAC-CE) or radio resource control (RRC), a second option associated with dynamic configuration of CCS resources via downlink control information (DCI), a third option associated with dynamic selection and reporting of CCS resources via physical uplink shared channel (PUSCH) symbol puncturing with a modulation and coding scheme (MCS) below a threshold, and a fourth option associated with WTRU dynamic selection and reporting of CCS resources via allocated extra resources for CCS.

14. The method of claim 11, wherein the method further comprises determining the CCS reporting mode out of the plurality of CCS reporting modes based on one or more of historical performance, channel condition, or peak-to-average power ratio (PAPR), power control parameters, or payload size of a generated CCS.

15. The method of claim 14, wherein the historical performance comprises average historical downlink (DL) throughput, average historical DL block error rate (BLER), compression rate, or average beamforming gain.

16. The method of claim 14, wherein the channel condition comprises channel measurements, wherein the channel measurements comprises one or more of rank indicator (RI), channel quality indicator (CQI), precoding matrix indicator (PMI), layer indicator (LI), CSI-RS resource indicator (CRI), reference signal received power (RSRP), signal-to-interference plus noise ratio (SINR), received signal strength indicator (RSSI), reference signal received quality (RSRQ), angle of arrival (AoA), area of departure (AoD), Doppler shift, Doppler spread, average delay, or delay spread.

17. The method of claim 11, wherein the method further comprises generating the CCS symbols based on CSI-RS measurements based on a joint source channel compression and modulation (JSCCM) artificial intelligence or machine learning (AI/ML) model.

18. The method of claim 11, wherein the method further comprises generating CSI feedback using a non-JSCCM CCS generator upon the condition that peak-to-average power ratio (PAPR) is above a threshold.

19. The method of claim 18, wherein, when the PAPR is above the threshold, the method further comprises performing separate source channel coding (SSCC)-based CSI reporting or legacy precoding matrix indicator (PMI)-based CSI reporting based on the CSI feedback.

20. The method of claim 11, wherein the report comprises the generated CCS symbols, the determined CCS reporting configuration, and the determined CCS reporting mode.
